(19) United States
(12) Patent Application Publication
(10) Pub. No.: US 2006/0123600 A1
(43) Pub. Date: Jun. 15, 2006

(54) Flexible grip

(76) Inventor: Harold F. Morse, Danvers, MA (US)

Correspondence Address: LAMBERT & ASSOCIATES, P.L.L.C., 92 STATE STREET, BOSTON, MA, 02109-2004, US

(21) Appl. No.: 11/298,343

(22) Filed: Dec. 9, 2005

Related U.S. Application Data
(60) Provisional application No. 60/635,133, filed on Dec. 10, 2004.

(51) Int. Cl. B25G 1/10

(52) U.S. Cl. 16/421

(57) ABSTRACT

The flexible grip of the present invention is a mountable and removable grip, intended for use with a variety of hand tools. The preferred embodiment contemplates use with screwdrivers. The flexible grip is never permanently fastened to the screwdriver handle, but is temporally fitted by compressive friction and/or interlocking.

### CROSS-REFERENCE TO RELATED APPLICATIONS

This application claims the benefit of U.S. Provisional Application No. 60/635,133 filed on Dec. 10, 2004.

### BACKGROUND OF THE INVENTION

1. Field of the Invention

This invention relates generally to the field of hand tool devices, and more particularly to grips for hand tools.

2. Description of the Related Art

The application of rotational and other forces is an important part of everyday life. One of the simplest examples of a rotational force in action is the driving of screw into a material. A typical screw's threads allow it to be driven into a variety of materials through the application of rotational forces. Some amount of axial force is typically also required to assist the boring action that the screw typically undergoes.

The simplicity of this example fails to disclose the numerous problems inherent in performing the task. Most problems occur in the area where the force is applied to the tool. In the case of a screwdriver application, the force is applied to the handle of the screwdriver, and is transmitted to the screw head. The obvious problems include insufficient axial force at the screw head, as well as insufficient rotational force to begin and/or maintain the boring of the screw into a desired material.

Both of these problems can be found to have a common root cause, centered on the location of where the force is applied by the user, i.e. the handle of the tool. Because the problems have long been recognized, a variety of solutions have been put forth in an attempt to correct them.

Other devices exist that attempt to provide a grip that enhances the user's ability to hold onto, or apply rotational force to the tool or similar article. These devices can be seen in a number of patents and a brief description of some of the more relevant prior art is provided as follows:

U.S. Pat. No. 4,098,506 issued to Gaiser discloses a hand grip sleeve for hand tools and the like. The hand grip of Gaiser is a tubular sleeve which is removable; has a high degree of compressibility; and is made from a non-woven fibrous material such as polyurethane foam or an ester-based polyurethane. A purpose of the hand grip of Gaiser is to provide a non-slipping, gripping surface for handles of hand tools and racket handles which may become coated with perspiration and oil.

U.S. Pat. No. 6,189,423 issued to Kaminiski discloses a torque-tool grip, torque tool and method. The grip of Kaminski is designed for use with torque tools such as screwdrivers. The grip of Kaminski has the configuration of a three sided bell that provides finger holds, bearing surfaces, and outlying lobes which alone or in combination improve torque capabilities an/or driving capabilities for the effort applied.

U.S. Pat. No. 6,652,941 issued to Chadwick et al. discloses a grip element and method of manufacture thereof. The grip of Chadwick et al. is configured for positioning over a hand-held article and is formed with at least two layers. The outer layer of the grip of Chadwick et al. is compressible, deformable, and flexible. The inner layer of the grip of Chadwick et al is manufactured from a relatively rigid material. The grip of Chadwick et al. may be tubular with a constant diameter or may be triangular in shape with rounded corners and tapering.

While these prior art solutions may be acceptable for their intended use, none of them provide a consistent, effective means to apply the most efficient application of rotational and axial forces to a hand tool.

Therefore, what is required is a method for applying efficient rotational and axial force to a hand tool.

What is also required is a device for applying efficient rotational and axial force to a hand tool.

What is further required is a device that is adaptable to a variety of different hand tools that may vary in shape and size.

Additionally, it is required to provide a device that is quickly and easily mountable and removable upon a variety of hand tools.

### BRIEF SUMMARY OF THE INVENTION

Therefore, it is an object of the present invention to provide a novel flexible grip that is easily mountable on the handle portion of a variety of hand tools.

It is also an object of the present invention to provide a flexible grip that may also be easily removed when desired by the user.

It is a further object of the present invention to provide a grip that resists rotation of the hand tool's rotation relative to the grip.

It is also an object of the present invention to provide efficient application of rotational and axial forces.

These and other features, aspects and advantages of the present invention will become better understood with reference to the following description, appended claims, and accompanying drawings where:

### BRIEF DESCRIPTION OF THE SEVERAL VIEWS OF THE DRAWINGS

FIG. 1 is perspective view of an embodiment of the present invention illustrating the proximal portion of the invention.

FIG. 2 is a sectional view of the flexible grip illustrating internal projections and a typical hand tool prior to insertion.

FIG. 3 is a side view of the present invention illustrating the planes 4 and 5 upon which sectional views are taken.

FIG. 4 is a sectional view taken along plane 4.

FIG. 5 is a sectional view taken along plane 5.

FIG. 6 is a perspective view of the present invention illustrating the distal portion of the present invention.

FIG. 7 is a front view of the stop plate of an embodiment of the present invention.

FIG. 8 is a side view of the present invention illustrating the plane upon which sectional view 9 is taken.

FIG. 9 is a sectional view of an embodiment of the present invention taken along plane 9.

FIG. 10 is a front view of the stop plate including a receptacle comprising a square, one-quarter inch drive receptacle.

### DETAILED DESCRIPTION OF THE INVENTION

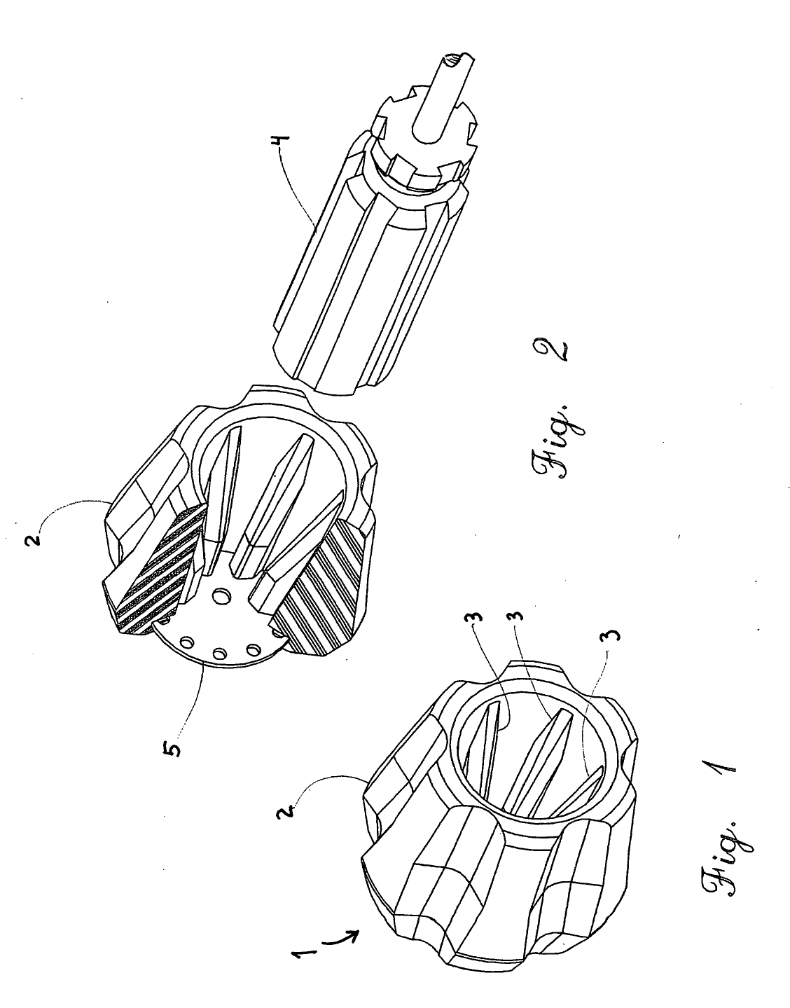

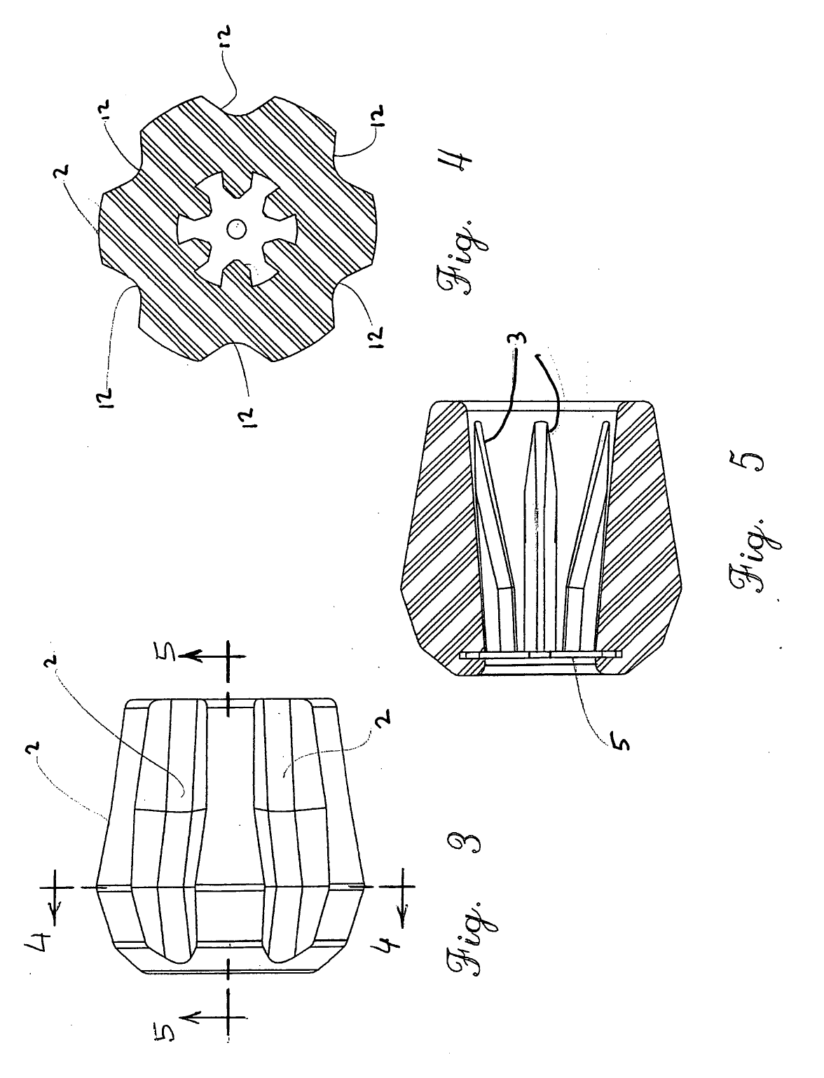

FIG. 1 illustrates an embodiment of flexible grip 1 of the present invention. External projections 2 are shown on the exterior surface of flexible grip 1, and internal projections 3 are shown within cavity 8. This embodiment is shown with six external projections, though those skilled in the art will appreciate that other numbers of external projections may be used and remain within the scope of the present invention.

FIG. 2 illustrates a section view of an embodiment of the flexible grip 1 that also displays the stop plate 5 located within a distal portion of the flexible grip 1. The internal projections 3 are seen as corresponding with the general shape of cavity 8 as it decreases in circumference moving in a direction from the proximal end to the distal end. This decrease in circumference aids in providing the frictional forces that result from insertion of hand tool 4. Hand tool 4 is illustrated as a standard screwdriver. It is known in the art that standard screwdrivers typically include six groove and projection pairs, which can be aligned to coordinate with six internal projections 3. If the handle portion of the screw driver does not include any grooves, or includes a number different from the number of internal projections 3, the flexible grip 1 will still be able to frictionally mount upon the handle portion of the hand tool 4 by means of the compressive action that occurs upon insertion. In the preferred embodiment, the internal projections 3 and grooves on the hand tool 4 correspond and increase the stability of the flexible grip 1 upon the handle portion of the hand tool 4. The stop plate 5 is typically imbedded within the flexible grip, and may be further secured by means of apertures located in the stop plate. Portions of the flexible grip may cooperate with these apertures thereby preventing the imbedded stop plate from twisting within the flexible grip 1 as part of a preferred embodiment. The stop plate 5 is also shown to include a receptacle 6 that may be used in the removal of the flexible grip 1 from the hand tool 4. By way of example, an object may be passed through receptacle 6 and pressure applied to the end of the hand tool to aid in the removal process.

FIG. 4 is a cross sectional view taken along plane 4, illustrating six external projections 2 of a preferred embodiment, and six internal projections 3 of a preferred embodiment. It will be also noted that in a preferred embodiment, the six internal projections 3 and external projections 2 correspond in an alternating fashion. The external projections in combination with the grooves 12 in between them provide enhanced gripping capability, which is important when rotational force is applied to the flexible grip 1 during operation.

FIG. 5 is a cross sectional view taken along plane 5, illustrating further the internal projections 3 as they follow the curvature of cavity 8. Cavity 8 may be considered to be substantially conical, but it does not need to correspond to a perfectly geometrical cone shape. Stop plate 5 may also be used to prevent the hand tool 4 from being pressed out the back of the flexible grip 1. In this way, the preferred embodiment therefore provides greater durability and longer useful life for repeated use.

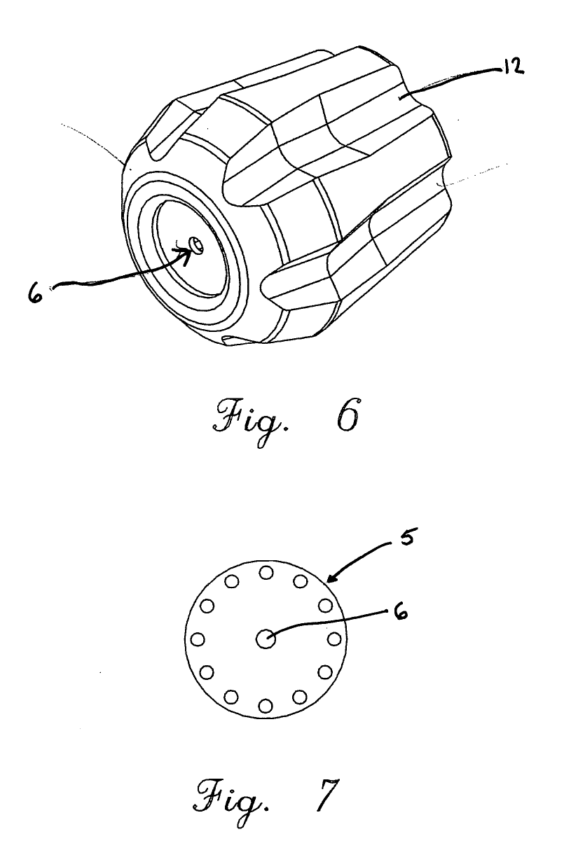

FIG. 6 illustrates a perspective view of the flexible grip 1 from the distal end of the device. This view includes an embodiment that illustrates the stop plate 5 and receptacle 6. The stop plate 5 of this embodiment is shown separately in a detailed view of FIG. 7.

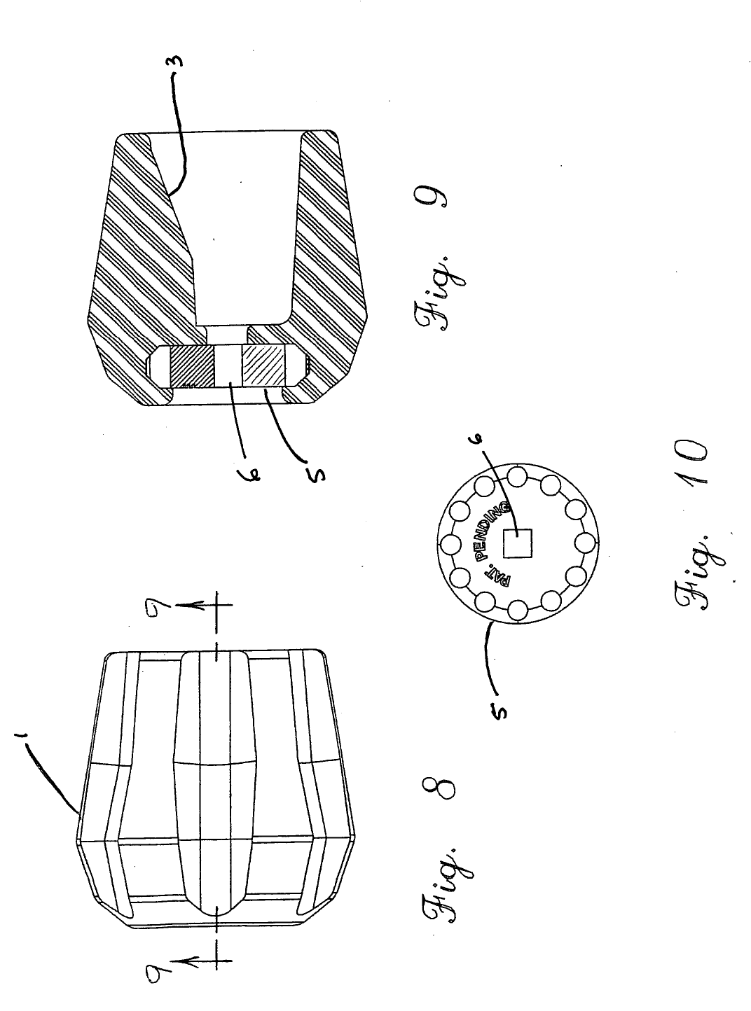

FIG. 8 illustrates a side view of the flexible grip 1 and plane 9 upon which the cross sectional view of FIG. 9 is taken. FIG. 9 includes an embodiment of stop plate 5 that comprises a receptacle capable of receiving an external driver. In this embodiment, the receptacle 6 is square-shaped to receive the typical one-quarter inch male fitting of a hand operated ratchet wrench, or the same fitting as applied to a powered instrument, such as a power drill fitted with the one-quarter inch fitting in lieu of a drill bit. The stop plate 5 in this embodiment is preferably slightly thicker when viewed from the side as n FIG. 9 to assist with the insertion and retention of an external driver.

The flexible grip 1 is preferably cast with a medium soft (rubberized) polyurethane, though other materials with similar properties may be suitably substituted. In application it is designed to fit snuggly over the plastic handle of almost any screwdriver regardless of the handle's shape and/or size. The cavity 8 and internal projections 3 will provide greatest resistance to undesired rotation of the flexible grip 1 relative to the hand tool 4 when the internal projections 3 align with grooves found on the typical hand tool handle portion. The stop plate 5 when comprising the preferred embodiment of a receptacle capable of receiving an external driver can be used with a powered tool to quickly and efficiently provide a great number of revolutions. When the torque becomes too great for the powered tool to accommodate, the external driver may be removed and any additional turns may be implement by hand utilizing the flexible grip 1 and hand tool 4 alone.

Additional advantages include increased torque as a result of the flexible grip having a greater diameter than the hand tool handle it is mounted upon. The flexible material and grooves located between the external projections create allow conformance of the users fingers allowing a greater sensitivity to, and greater control over, the amount of torque applied at any given instant to the screw head. Additionally, the flexible material and grooves combine to provide a spring like power to the rotating process as a result of the resiliency of the flexible grip body.

The soft back side of the flexible grip also conforms well to the human palm and allows the user to apply much more thrust towards the screw head in an axial direction. This results in less slippage at the screw head, and in turn, less stripping of the screw head material.

The length of the flexible grip is approximately two and six tenths inches in a preferred embodiment. This feature results in the flexible grip only mounting upon approximately the last two inches of the handle portion of the hand tool. The unmounted portion of the handle thus remains available for the user to apply additional force with the other hand as necessary. The result is more speed and power, thereby achieving the most efficient force application in both the rotational and axial vectors.

In addition to the device itself, the present invention also includes a method for using the flexible grip to apply rotational and axial forces. In practice, the typical screwdriver handle is between twenty-two to thirty millimeters in diameter. In a preferred embodiment, the cavity 8 of the flexible grip has a proximal end circumference of about thirty-two millimeters, and a distal end circumference of about twenty-two millimeters at its inner most point. When a handle is inserted into the cavity, the entire grip experiences some stretching, while the internal projections 3 are compressed. The resiliency of the materials then provides a powerful frictional force that prevents slipping of the hand tool, even when a high degree of rotational force is applied. In an embodiment where the receptacle comprises a one-quarter inch drive receptacle, any ratchet style wrench may be utilized, or a power tool adapted with a one-quarter inch fitting may also be used.

What is claimed is:

1. A flexible grip comprising:
a grip body, wherein said grip body includes a proximal and distal end, an exterior surface and an interior surface, and wherein said interior surface includes portions defining a cavity; and
at least one internal projection, wherein said at least one internal projection is connected to said interior surface.

2. The flexible grip of claim 1, wherein said cavity includes a cavity circumference, wherein said cavity circumference varies in a direction moving from said proximal end toward said distal end.

3. The flexible grip of claim 2, wherein said cavity circumference decreases in the direction moving from said proximal end toward said distal end.

4. The flexible grip of claim 3, wherein said internal projections comprise a resilient material.

5. The flexible grip of claim 4, wherein said grip body comprises a resilient material.

6. The flexible grip of claim 5, wherein said grip body further comprises at least one external projection.

7. The flexible grip of claim 6, wherein said grip body further comprises six external projections.

8. The flexible grip of claim 5, wherein said grip body further comprises a body length, wherein said body length is substantially three inches.

9. The flexible grip of claim 5, wherein said body length is substantially at least two inches and substantially at most three inches.

10. The flexible grip of claim 5, wherein said body length is substantially two and six-tenths inches.

11. The flexible grip of claim 5, further comprising a stop plate, wherein said stop plate is imbedded within a portion of the grip body, said portion of the grip body being located near the distal end of said grip body.

12. The flexible grip of claim 11, wherein said stop plate is substantially rigid.

13. The flexible grip of claim 12, wherein said stop plate further comprises a metallic material.

14. The flexible grip of claim 13, wherein said stop plate further comprises a substantially circular shape.

15. The flexible grip of claim 14, wherein said stop plate includes portions defining a receptacle.

16. The flexible grip of claim 15, wherein said receptacle further comprises portions capable of receiving an external driver.

17. The flexible grip of claim 15, wherein said receptacle further comprises a substantially one-quarter inch square drive receptacle.

18. The flexible grip of claim 15, wherein said external driver is a hand operated ratchet-style wrench.

19. The flexible grip of claim 15, wherein said external driver is a powered tool.

20. A flexible grip comprising:
a grip body, wherein said grip body includes a proximal and distal end, an exterior surface and an interior surface, and wherein said interior surface includes portions defining a conical cavity;
a plurality of internal projections connected to said interior surface;
a plurality of external projections located on said exterior surface; and
a stop plate imbedded in a portion of the grip body, wherein said portion of the grip body is located near the distal end of said grip body, and wherein said stop plate further comprises a receptacle.

21. The flexible grip of claim 20, further comprising six internal projections.

22. The flexible grip of claim 21, wherein said receptacle is substantially circular.

23. The flexible grip of claim 21, wherein said receptacle further comprises portions capable of receiving an external driver.

24. The flexible grip of claim 23, wherein said receptacle further comprises a substantially one-quarter inch square drive receptacle.

27. A method for providing efficient rotational and axial forces by means of a flexible grip, wherein said method comprises the steps of:
a) inserting a handle portion of a hand tool into a conical shaped cavity of a grip body of said flexible grip;
b) compressing internal projections located within said cavity by means of the handle portion of a hand tool;
c) applying a rotational force to said grip body

28. The method of claim 27, further comprising the step of aligning said internal projections with corresponding hand tool grooves, wherein said hand tool grooves are located on the handle portion of the hand tool.

29. The method of claim 28, further comprising the step of applying an axial force to said grip body in conjunction with the step of applying a rotational force to said grip body.

30. The method of claim 29, wherein said exterior surface includes a plurality of external projections.

31. The method of claim 30, further comprising the step of stopping the insertion of said handle portion of a hand tool into said grip body by means of a stop plate.

32. The method of claim 31, wherein said stop plate includes a receptacle.

33. The method of claim 32, further comprising the step of removing said flexible grip from the handle portion of the hand tool by projecting a cylindrical tool through the receptacle.

34. The method of claim 33, wherein said receptacle comprises portions capable of receiving an external driver.

35. The method of claim 34, wherein said external driver is a hand operated ratchet-style wrench.

36. The method of claim 34, wherein said external driver is a powered tool.
